(19) United States
(12) Patent Application Publication
(10) Pub. No.: US 2005/0228882 A1
(43) Pub. Date: Oct. 13, 2005

(54) Apparatus, system and program for issuing presence information

(75) Inventors: Masafumi Watanabe, Tokyo (JP); Naoko Ito, Tokyo (JP); Natsuko Tsutazawa, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 11/085,095

(22) Filed: Mar. 22, 2005

(30) Foreign Application Priority Data
Mar. 25, 2004 (JP) 2004-089260

(51) Int. Cl. G06F 15/173; G06F 15/16

(52) U.S. Cl. 709/224; 709/219

(57) ABSTRACT

Disclosed is a system in which the status of a user is automatically inferred without relying on the user's manual input, and the so inferred status is displayed. The status of the user, making use of or holding a device, such as a mobile phone, is inferred from the use pattern of the device or from the information derived from sensors mounted to the device and the so inferred status of the user is issued as the presence information. On receipt of the information derived from the use pattern of the device or from sensors mounted to the device, the status calculation unit calculates the user's presence information based on calculating rules as held on a computation rule holding unit to issue the results as the presence information.

### FIELD OF THE INVENTION

This invention relates to status analysis for inferring the status of a user, as a source of transmission of input information, based in particular on speech information, to use the so inferred status for an apparatus for recording or display.

### BACKGROUND OF THE INVENTION

A presence system means a system for supervising the status of people, articles or services at large. The presence system, the basic architecture of the system of which is shown in RFC 2778, is made up by a presence information management means for providing own presence information, a watcher observing it, and a presence service for receiving the presence information from the presence information management means for distribution to the watcher. The presence information management user agent, as referred to in the following explanation, is specifically a program for providing the functions of the presence information management means.

In conventional presence services, the presence values, other than the states of communication, such as online state or offline state, as presumed from the client-presence service connection, were manually set by the user. Consequently, the presence information, provided by the user, is low in reliability, such as by the user forgetting to change the state (for example, see the JP Patent Document 1).

[Patent Document 1]

JP Patent Kokai Publication No. JP-P2003-167900A

### SUMMARY OF THE DISCLOSURE

If, with the aid of the conventional presence information management user agent, the user's status is to be notified, as the presence information, a suitable candidate is selected from a status describing list, provided in advance, to update and notify the presence information.

With this method, in which suitable status description is checked by the user, there is raised a problem that, if the number of status descriptions is increased, the user becomes unable to deal with the situation. Although it is possible for the user to formulate optional status descriptions, the inputting operation itself is extremely labor-consuming.

With pre-existing presence information management user agents, such as “Windows Messenger” of Microsoft Inc. or “Yahoo! Messenger” of YAHOO Co. Ltd., it is necessary to act on an inputting device, such as a keyboard or a mouse, for updating the presence information. However, changes in the user status may occur as he/she is not aware of the changes caused. Consequently, there is raised a problem that, since the user is apt to forget updating the presence information, the reliability of the presence information is lowered.

On the other hand, the presence information management user agent, actuated by operation by a user, suffers from an inconvenience that, if the person doing the operation is busy in the conversation, the presence information cannot be notified at a proper timing.

Even with the conventional presence information management user agent, it is possible for the program to detect that the device is being used and to issue the presence information that the user is employing the device. However, there has not been proposed a scheme in which the program automatically notifies the presence information specifying the particular status of the user, for example the status indicating that the user is unable to respond to the telephone call, has not read mails or is requesting the communication.

In view of the above-depicted status of the art, it is an object of the present invention to provide a system and an apparatus for issuing presence information whereby the user's status may be automatically inferred and recorded or displayed, without relying upon the manual input by the user.

The present invention is directed to a system according to which the status of a user employing or holding a device is inferred from the use pattern of the device or from the information acquired from a sensor(s) loaded on the device and the so inferred status of the user is issued as the presence information.

On receipt of the use pattern of the device, or the information acquired from the sensor(s) loaded on the device, a status computing unit of the present invention derives the presence information of the user, based on the computation rule as retained by the computation rule holding unit, and issues the results as the presence information.

In one aspect, the present invention provides an apparatus for issuing presence information comprising:
means for extracting a variety of parameters making up the input information;
means for inferring the status of a source of transmission of the input information based on the various parameters extracted by the extracting means;
means for holding the status inferred last time by the inferring means, and means for comparing the status inferred last time and held by the holding means and the status inferred for the present time by the inferring means, and for outputting the status inferred for the present time by the inferring means as the status information in case the status inferred last time and held by the holding means and the status inferred for the present time by the inferring means differ from each other.

The apparatus may further comprise means for holding one or plurality of inference computation rules for the inferring means.

The apparatus may further comprise means for holding the last input time of the input information which is the speech information, and means for sending out a preset message as a speech signal in case no new speech information is entered even after lapse of preset time as from the last input time held by the holding means.

Thus, by prompting the conversation for the user, the information for comprehending the user's state may be acquired reliably.

The apparatus may further comprise means for holding the last input time of the input information which is the operation input information, and means for executing a preset operation input invoking procedure in case no operation input is entered even after lapse of preset time as from the last operation input time held by the holding means.

Thus, by prompting an operation input from the user, in the absence of an operation input from the user, the information for comprehending the user's state may be acquired reliably.

In a second aspect, the present invention provides a presence information issuing system comprising a user device, which user device includes means for extracting various parameters making up the input information, and filtering means for filtering out preset ones of the various parameters extracted by the extracting means, and a presence server, which presence server includes means for inferring the status of a source of transmission of the input information based on the various parameters filtered out by the filtering means, means for holding the status inferred last time by the inferring means, and means for comparing the status inferred last time and held by the holding means and the status inferred for the present time by the inferring means, and for outputting the status inferred for the present time by the inferring means as the status information in case the status inferred last time and held by the holding means and the status inferred for the present time by the inferring means differ from each other.

The presence information issuing system may further comprise means for holding one or plurality of filtering rules used by the filtering means, and means for holding one or plurality of inference computation rules for the inferring means.

In this case, the presence information issuing system may be provided with the user device and with the presence server as distinct devices. For example, the user device is a mobile phone owned by a user, and the presence server may be provided as equipment owned by a mobile phone servicing business organization.

The user device may include filtering means to inhibit outflow of the private information the leakage of which to outside is not desirable for the user. Which information is to be filtered out may be determined by filtering rules provided by the user.

The system for issuing presence information may again further comprise means for holding the last input time of the input information which is the speech information, and means for sending out a preset message as a speech signal in case no new speech information is entered even after lapse of preset time as from the last input time held by the holding means.

Or, the apparatus for issuing presence information may further comprise means for holding the last operation input time by a user for the user device, and means for executing a preset operation input invoking procedure in case no new operation input is entered even after lapse of preset time as from the last operation input time held by the holding means.

In a third aspect, the present invention provides a user device comprising means for extracting various parameters making up the input information, and filtering means for filtering out preset ones of the various parameters extracted by the extracting means. There may further be provided with means for holding one or plurality of filtering rules used by the filtering means.

The user device may further comprise means for holding the last input time of the input information which is the speech information, and means for sending out a preset message as a speech signal in case no new speech information is entered even after lapse of preset time as from the last input time held by the holding means.

The user device may further comprise means for holding the last operation input time by a user to the user device, and means for executing a preset operation input invoking procedure in case no operation input is entered even after lapse of preset time as from the last operation input time held by the holding means.

In a fourth aspect, the present invention provides a presence server comprising means for inferring the status of a source of transmission of input information based on various parameters extracted from the input information, means for holding the status inferred last time by the inferring means, and means for comparing the status inferred last time and held by the holding means and the status inferred for the present time by the inferring means, and for outputting the status inferred for the present time by the inferring means as the status information in case the status inferred last time and held by the holding means and the status inferred for the present time by the inferring means differ from each other. There may further be provided with means for holding one or plurality of inference computation rules for the inferring means.

In a fifth aspect, the present invention provides a computer program which, when installed on an information processing apparatus, enables the information processing apparatus to implement the functions equivalent to those of a presence information issuing apparatus comprising the functions of extracting a variety of parameters making up the input information, inferring the status of a source of transmission of the input information based on the parameters extracted by the extracting functions, holding the status inferred last time by the inferring function, and comparing the status inferred last time and held by the holding function to the status inferred for the present time to output the currently inferred status as the status information by the inferring function in case of the two statuses differing from each other. There may further be implemented the function of holding one or plurality of inference computation rules of the inferring functions.

The computer program may further implement the functions of holding the last input time point of the input information which is the speech information, and send out a preset message as speech signals in case no new speech information is input even after lapse of a preset time as from the last input time held by the holding function.

The computer program implements the functions of holding the last operation input time by a user to the user device, and executing a preset operation input invoking procedure in case no operation input is entered even after lapse of preset time as from the last operation input time held by the holding function.

In a further aspect, the present invention provides a computer program which, when installed on an information processing apparatus, enables the information processing apparatus to implement the functions equivalent to those of a user device comprising the functions of extracting a variety of parameters making up the input information, and filtering out preset ones of the various parameters extracted by the extracting function. The program may further implement the functions of holding one or plurality of filtering rules employed by the filtering functions.

The computer program may further implement the functions of holding the last input time of the input information which is the speech information, and sending out a preset message as a speech signal in case no new speech information is entered even after lapse of preset time as from the last input time held by the holding function.

The computer program may further implement the functions of holding the last operation input time by a user to a user device, and executing a preset operation input invoking procedure in case no operation input is entered even after lapse of preset time as from the last operation input time held by the holding function.

In yet another aspect, the present invention provides a computer program which, when installed on an information processing apparatus, enables the information processing apparatus to implement the functions equivalent to those of a presence server including the functions of inferring the status of a source of transmission of input information based on the various parameters extracted from input information, holding the status inferred last time by the inferring function, and comparing the status inferred last time and held by the holding function and the status inferred for the present time by the inferring function, and for outputting the status inferred for the present time by the inferring function as the status information in case the status inferred last time and held by the holding function and the status inferred for the present time by the inferring function differ from each other. The program may also implement the functions of holding on a plurality of inference computation rules for the inferring function.

By recording the program of the present invention on a recording medium, the information processing apparatus is able to install the program of the present invention, with the aid of the recording medium. Or, the program of the present invention may be installed from a server holding the program of the present invention directly on the information processing apparatus over a network.

Thus, there may be provided a system and an apparatus for issuing presence information in which the user's state may automatically be inferred and displayed, using a general-purpose information pro apparatus, without relying upon manual inputs by a user.

The meritorious effects of the present invention are summarized as follows.

The conventional presence information management server user agent was unable to notify changes in the feeling, humor or stress degree of the human being as the presence information automatically to a watcher. The present invention addresses to this problem.

The first meritorious effect of the present invention is that it is unnecessary for the human being to select a suitable candidate for status description, or to formulate optional status description. A status computing unit computes the status description from conversation parameters in accordance with calculating rules as stored in e.g. a calculating rule holding unit. Since the above-described processing is carried out by a program, the human being may be relieved of the load of selecting a suitable candidate for status description or the load of preparing the status description itself. The processing time is also shorter than if the user performs the operation.

The second meritorious effect is that even status changes, of which a user may not be aware, may be notified as presence information more reliably than in the case of manual inputting. The reason is that the conversation parameter extraction unit is able to automatically collect various parameters pertinent to the human conversation.

The third meritorious effect is that the status of a user may be notified to the presence service even if the user is busy in conversation. The reason is that, if the presence information management user agent is enclosed in the mobile phone, the conversation parameter extracting unit is able to extract parameters pertinent to the conversation if only the conversation is had over the mobile phone.

The fourth meritorious effect is that not only the presence information indicating the online state or the device using state is automatically issued to the device but also the presence information indicating the specified status of the user may also be issued automatically.

Still other objects and advantages of the present invention will become readily apparent to those skilled in this art from the following detailed description in conjunction with the accompanying drawings wherein only the preferred embodiments of the invention are shown and described, simply by way of illustration of the best mode contemplated of carrying out this invention. As will be realized, the invention is capable of other and different embodiments, and its several details are capable of modifications in various obvious respects, all without departing from the invention. Accordingly, the drawing and description are to be regarded as illustrative in nature, and not as restrictive.

### BRIEF DESCRIPTION OF THE DRAWINGS

FIG. 1 is a block diagram showing the configuration of a presence issuing module of a first embodiment.

FIG. 2 shows an example of the presence information.

FIG. 3 shows an example of the previous presence information.

FIG. 4 is a flowchart showing the operation of the first embodiment.

FIG. 5 is a block diagram showing the configuration of a presence issuing module of a second embodiment.

FIG. 6 is a flowchart showing the operation of the second embodiment.

FIG. 7 is an overall view showing a presence issuing module of a third embodiment.

FIG. 8 is a flowchart showing the operation of the third embodiment.

FIG. 9 is a block diagram showing the configuration of a mobile phone of a fourth embodiment.

FIG. 10 is a flowchart showing the operation of the fourth embodiment.

### PREFERRED EMBODIMENTS OF THE INVENTION

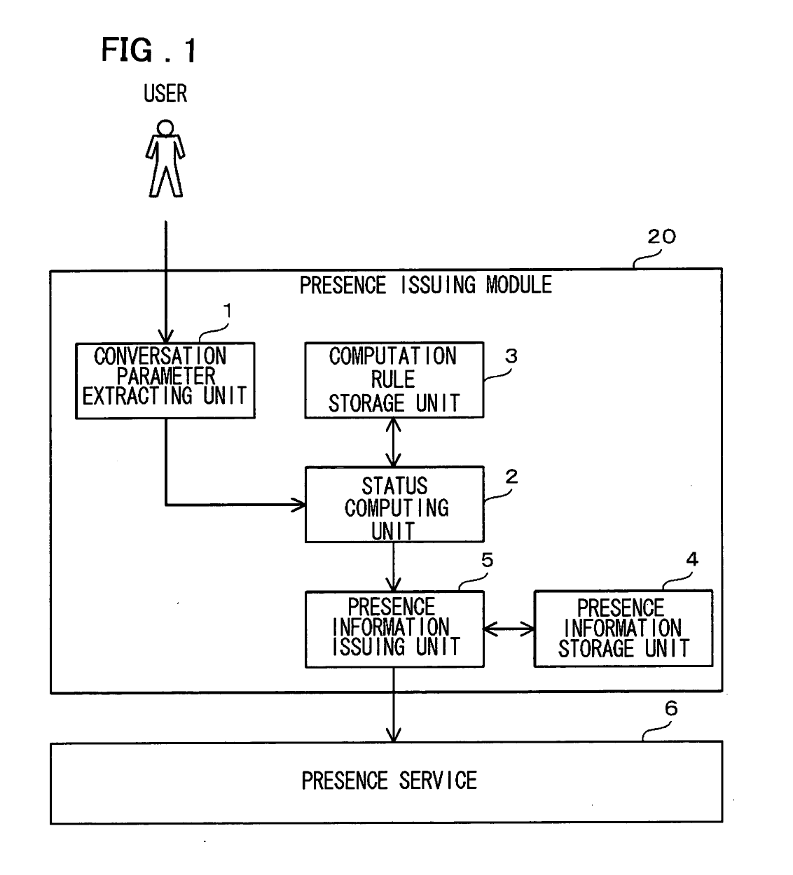

Referring to FIG. 1, a presence issuing module, as a presence information issuing device according to a first embodiment of the present invention, is now described. FIG. 1 is a block diagram showing a presence issuing module 20 according to the first embodiment.

The presence issuing module 20, shown in FIG. 1, includes a conversation parameter extracting unit 1, a status computing unit 2, a computation rule storage unit 3, a presence information storage unit 4 and a presence information issuing unit 5. The conversation parameter extracting unit 1 extracts various parameters making up the speech information as the input information. The status computing unit 2 for inferring the status of the user as a source of transmission of the speech information, based on the above-mentioned various parameters, as extracted from the conversation parameter extracting unit 1. The computation rule storage unit 3 holds inference computation rules for the status computing unit 2. The presence information storage unit 4 holds the status inferred last time by the status computing unit 2. The presence information issuing unit 5 compares the status inferred last time and held by the presence information storage unit 4 to the status currently inferred by the status computing unit 2 and, if the two statuses differ from each other, outputs the status currently inferred by the status computing unit 2 as the status information.

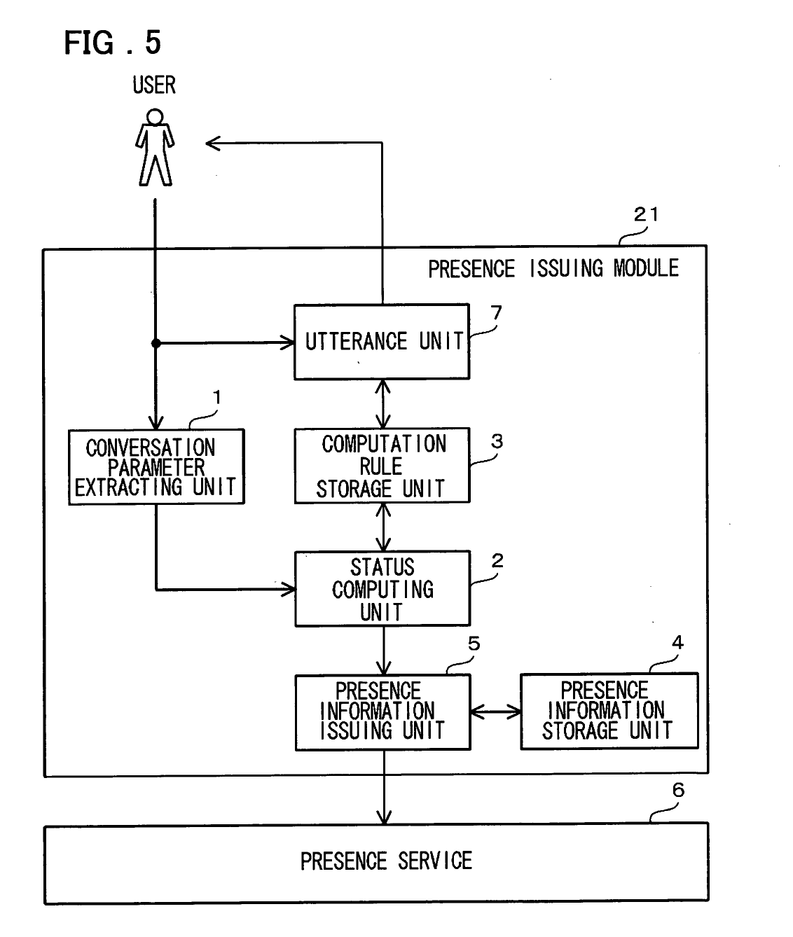

FIG. 5 shows a presence issuing module 21 according to the second embodiment. In the second embodiment, an utterance unit 7 is provided, as shown in FIG. 5. This utterance unit 7 includes a means (not shown) for holding the last input time point for the speech information, as the input information, and a means (not shown) for sending out a preset message, as a speech signal, in case no new speech information is not entered after lapse of preset time as from the last input time as held by the holding means.

Or, the utterance unit may include a means for holding the last input time point of operation input information, as input information, and a means for executing a preset operation input invoking procedure in case no new speech information is not entered after lapse of preset time as from the last operation input time as held by the holding means. The holding means and the executing means (both not shown) may be provided in the utterance unit 7 shown in FIG. 5. In this case, the operation input information is entered to the utterance unit 7 along with the user's speech information.

The operation input information herein is the operation input information in the user device, such as a mobile phone or a PDA having the presence issuing module 21 built therein. The inputting of the operation input information in FIG. 5 is omitted from the drawing, only for simplicity.

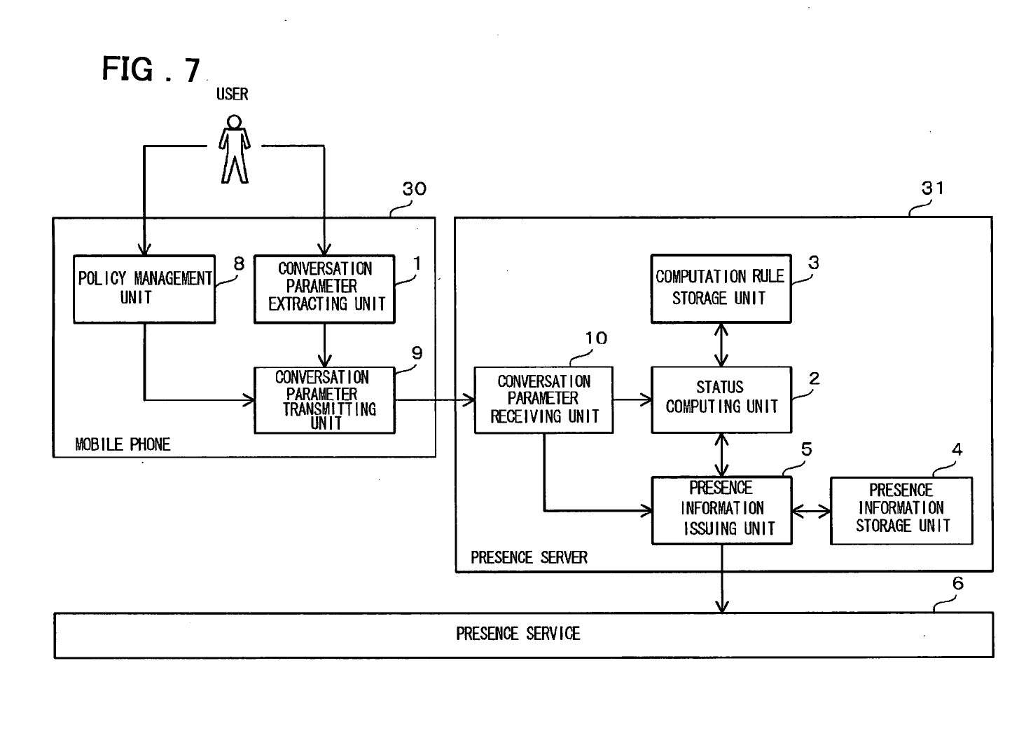

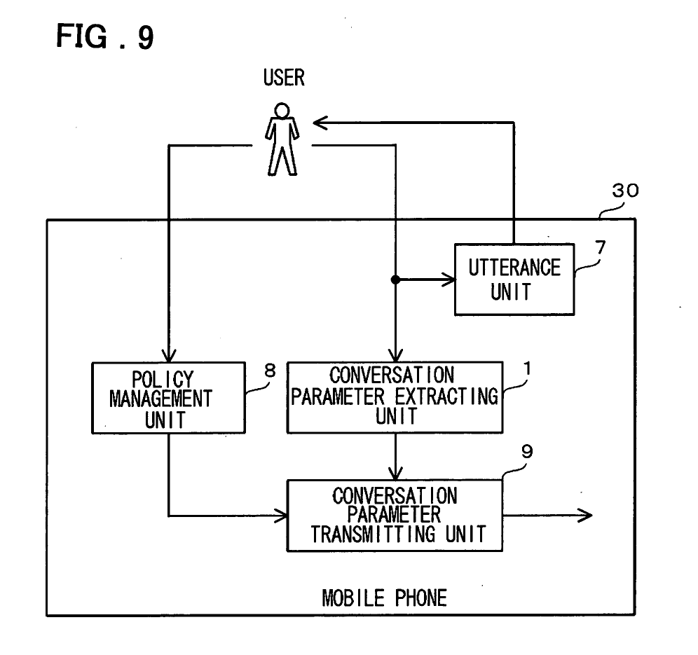

FIG. 7 shows a presence information issuing system according to a third embodiment of the present invention. Referring to FIG. 7, the presence information issuing system according to the third embodiment includes a mobile phone 30, as a user device, and a presence server 31. The mobile phone 30 includes a conversation parameter extracting unit 1 for extracting various parameters, making up the speech information, as the input information, a conversation parameter transmitting unit 9 for filtering preset one(s) of the various parameters extracted by the conversation parameter extracting unit 1, and a policy management unit 8 for holding filtering rules used by the conversation parameter transmitting unit 9. The presence server 31 includes a status computing unit 2 for receiving the various parameters, filtered by the conversation parameter transmitting unit 9, via conversation parameter receiving unit 10, and for inferring the status of the source of transmission of the speech information, based on the above-mentioned various parameters, a computation rule storage unit 3 for holding inference computation rules of the status computing unit 2, a presence information storage unit 4 for holding the status inferred last time by the status computing unit 2, and a presence information issuing unit 5 for comparing the status inferred last time and held by the presence information storage unit 4 to the status currently inferred by the status computing unit 2 and outputs the status currently inferred by the status computing unit 2 as the status information if the two statuses differ from each other. Referring to FIG. 9, the utterance unit 7 may be provided in the mobile phone 30 in the third embodiment, as in the second embodiment (fourth embodiment).

There may further be provided a means for holding the last operation input time to the mobile phone 30 by a user, and a means for invoking a preset operation input invoking procedure in case no new operation input occurs after lapse of preset time as from the last operation input time as held by the holding means. The holding means and the executing means (both not shown) may be provided in the utterance unit 7 shown in FIG. 9. In this case, the utterance unit 7 is supplied with the operation input information along with the user's speech information. The inputting of the operation input information is omitted form the drawing, only for simplicity.

The present embodiment is implemented as a program which is installed on a general-purpose information processing apparatus to implement in the information processing apparatus the functions equivalent to those of the presence issuing modules 20, 21 of the first and second embodiments or the mobile phone 30 and the presence server 31 in the third and fourth embodiments. This program may be recorded on a recording medium and installed in this status on an information processing apparatus, or downloaded on the information processing apparatus from the communication network, in order to implement in the information processing apparatus the functions equivalent to those of the conversation parameter extracting unit 1, status computing unit 2, computation rule storage unit 3, presence information storage unit 4, presence information issuing unit 5, utterance unit 7, policy management unit 8, conversation parameter transmitting unit 9 and a conversation parameter receiving unit 10.

The embodiment of the present invention is now further explained in detail.

On receipt of a device utilizing pattern or the information acquired by a sensor loaded on a device, the status computing unit 2 derives the presence information of a user, based on the computation rules, as stored in the computation rule storage unit 3. The results as calculated are issued as the presence information by the presence information issuing unit 5.

The computation rules may be exemplified by
(1) those inferring that, judging from the reaction time from a user responsive to an operation prompting an action on the part of the user, that the user is not available (i.e. the user being busy or outing);
(2) those inferring the status of the user depending on the frequency of the user utilizing a device, such as a mobile phone;
(3) those inferring the status of the user depending on which of the functions, as loaded on a device, such as mobile phone, is exploited by the user, for example, those inferring that the user is not busy when the user is playing a game or that the user is busy when the user is exploiting the function of call by voice;
(4) those inferring the status of the user from the input information itself to a device, such as mobile phone, for example, those inferring the humor of the user from the status of his/her voice in voice communication; and
(5) those inferring the status of the user from the number of items or data stored in a device, such as mobile phone, for example, those inferring whether or not the user is reading mails diligently. These may also be combined together to make up computation rules.

The presence information, transmitted in accordance with the present invention, may be exemplified by
(1) the information which invites others to select means for communication or transactions, for example, the information indicating that the user is in a noisy place and cannot phone, or
(2) the information which prompts others to initiate communication or transactions, for example, the information indicating that the user is not busy.

For acquiring the information as input to the status computing unit 2, an action prompting an input may be produced from a device, such as mobile phone. Specified examples are now explained in order.

### EXAMPLE 1

The configuration of Example 1 is now described with reference to FIG. 1. Changes in the user's status are converted by a presence issuing module 20 into the presence information, which is issued to a presence service 6.

The present Example 1 extracts voice parameters from speech from call by voice over the mobile phone to compute the presence information in the status computing unit 2. Among the parameters, relevant to speech, there are, for example, the loudness and the pitch of the voice, and the speed with which conversation proceeds.

The presence information, computed from the speech parameters, may be exemplified by the feeling or busyness of the user. As for the computation rules for computing the presence information from the voice parameters, there are applied such rules that ‘the user is excited if his/her voice is loud and of high pitch’ or ‘the user is speaking confidentially and busy if his/her voice is quiet and of low pitch’.

The presence issuing module 20 includes a conversation parameter extracting unit 1, a status computing unit 2, a computation rule storage unit 3, a presence information storage unit 4 and a presence information issuing unit 5. The conversation parameter extracting unit 1 collects one or more parameters, relevant to the conversation by the user, by a technique used in speech analysis, or natural language processing.

The computation rule storage unit 3 stores rules for deriving the description of the user's status, from a variety of conversation parameters. The status computing unit 2 executes the processing of deriving the status description from the conversation parameters, as collected by the conversation parameter extracting unit 1, in accordance with the computation rules as stored in the computation rule storage unit 3.

The status computing unit 2 also has the functions of delivering the so derived status description to the presence information issuing unit 5. The presence information storage unit 4 has the function of transiently storing the presence information issued last time to the presence service 6. The presence information issuing unit 5 has the functions of preparing the new presence information from the status description delivered from the status computing unit 2, comparing the new presence information to the presence information saved in the presence information storage unit 4 and issuing the new presence information to the presence service 6.

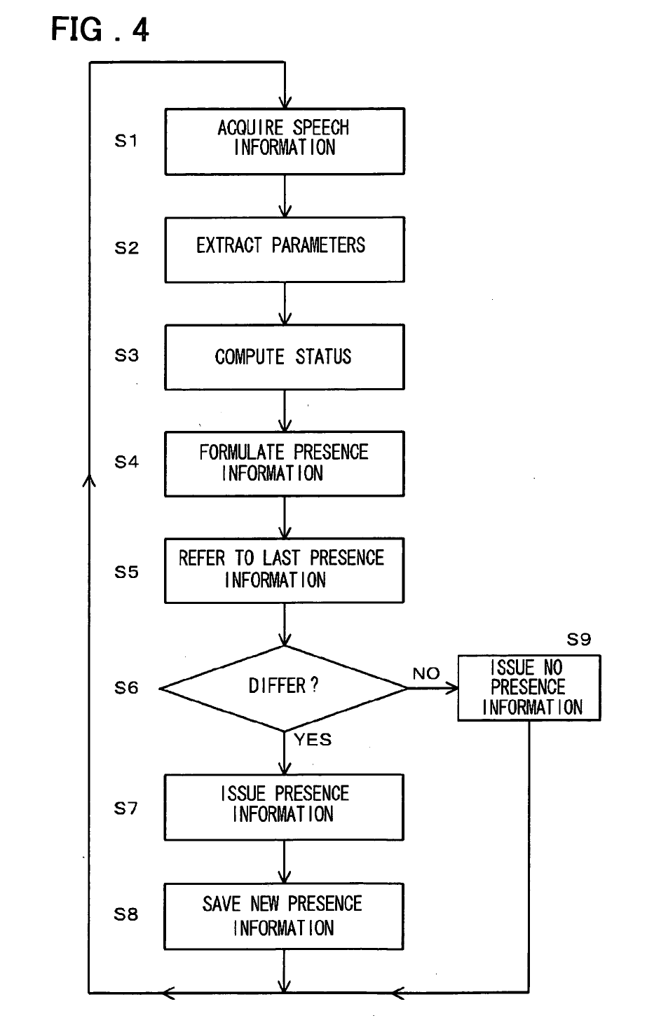

The operation of the first embodiment is now described with reference to FIG. 4, which is a flowchart showing the operation of the Example 1.

Step S1 (acquisition of the speech information): The speech information is entered to the conversation parameter extracting unit 1.

Step S2 (parameter extraction): When the user has a conversation, the conversation parameter extracting unit 1 extracts conversation parameters by a technique used in speech analyses or natural language processing. For the present explanation, it is assumed that the conversation parameters have been successfully extracted with the loudness of the voice (medium), loudness of the voice (quiet) and the conversation speed (quick) as parameters. The parameter extracting unit 1 delivers the parameters (loudness=medium, pitch=medium and conversation speed=slow) to the status computing unit 2.

Step S3 (status computations): The status computing unit 2 applies the following computation rules, saved in the computation rule storage unit 3, to the parameters. The status computing unit 2 derives the status description “<feeling> relaxed </feeling>”, as being the result for the parameters (loudness=medium, pitch=medium and conversation speed=slow) to deliver the status description to the presence information issuing unit 5.

A) If the pitch of the voice=medium, loudness of the voice=medium and the conversation speed=slow, then the status=“<feeling> relaxed </feeling>”.

B) If the pitch of the voice=high, loudness of the voice medium and the conversation speed=quick, then the status=“<feeling> nervous </feeling>”.

C) If the pitch of the voice=low, loudness of the voice=quiet and the conversation speed=quick, then the status=“<feeling> busy </feeling>”.

D) If the pitch of the voice=high, loudness of the voice=loud and the conversation speed=quick, then the status=“<feeling> excited </feeling>”.

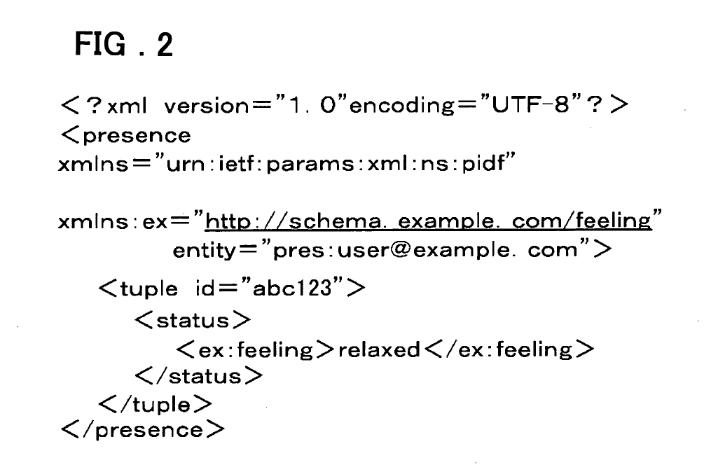

Step S4 (preparation of the presence information): The presence information issuing unit 5 prepares the presence information of FIG. 2, including the status description “<feeling> relaxed </feeling>”, received in the step S3.

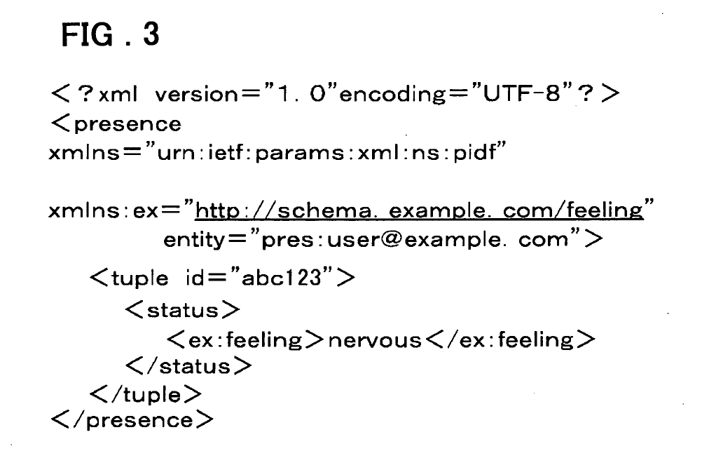

Step S5: (reference to directly previous presence information): The presence information of FIG. 3, issued last time to the presence service, has been saved in the presence information storage unit 4.

Step S6 (Comparison): The presence information issuing unit 5 compares the presence information, prepared in the step S4, to the presence information saved in the presence information storage unit 4.

Step S7 (Issuance of presence information): Since the two differ from each other, the presence information issuing unit 5 issues the new presence information to the presence service 6.

Step S8: (Saving of new presence information): The presence information, issued by the presence information issuing unit 5, is delivered to the presence information storage unit 4 as well. The presence information storage unit 4 discards the old presence information it held so far and saves the new presence information delivered from the presence information issuing unit 5.

Step S9 (Issuing no presence information): If the presence information, saved in the presence information storage unit 4 last time, is the same as the current presence information, no presence information is issued by the presence information issuing unit 5.

(Example of Application 1)

An example of application in which the number of times of call incoming per unit time is acquired from the mobile phone to issue the presence information is now described. It may be inferred that the larger and the smaller the number of times of call incoming, the more busy and the less busy is the user, respectively.

In the computation rule storage unit 3, there is stored e.g. the computation rule: ‘if the number of times of telephone call incoming per 10 minutes≧three times, then the status=“busy”’. If ‘three times’ is received by the status computing unit 2 as the number of times of telephone call incoming per minute, the status computing unit issues the status ‘busy’ in accordance with the above rule.

The presence information issuing unit 5 issues the presence information, representing the ‘busy’ status, to the presence service 6. As the presence information, the presence information indicating that the user is kept busy dealing with frequent telephone calls, may be issued in addition to the ‘busy’.

By the present Example of Application, it may automatically be imparted to a watcher that the user is kept busy in dealing with frequent incoming telephone calls. A watcher desirous to make a telephone call to this user may wait a little while before making a call.

It may be inferred that the larger and the smaller the number of times of telephone calls per unit time, as acquired from a mobile phone, the more busy and the less busy is the user, respectively. The computation rule for this case may be such that ‘if the number of times of telephone calls per ten minutes, ≧three times, then the status=“busy”’.

The number of times per unit time may also be counted as the busy time of the user is excluded. For example, the computation rule may be such that ‘if the number of times of incoming telephone calls per ten minutes of the latest waiting time, ≧three times, then the status=“busy”’. By so doing, the busyness of the user may be inferred more correctly. The busyness of the user may similarly be inferred in case the number of calls from the user is substituted for the number of incoming calls.

The number of times of incoming telephone calls that could not be dealt with by the user may be acquired from the mobile phone of the user to apply the computation rule such that ‘if there is any incoming telephone call, then the status=“busy”’. It may be inferred that the more the number of times of incoming telephone calls that had no response (could not be dealt with), the more busy is the user.

It is also possible to acquire the number of times of incoming telephone calls that could not be dealt with by the user and the access time by the ring tone or a vibrator may also be acquired to apply the computation rule such that ‘if there is any incoming telephone call that could not be dealt with despite access for a time period longer than a preset time, then the status=“busy”’.

By using the telephone directory function of the mobile phone in combination, more detailed presence information may be acquired. The attributes of a counterpart party, registered in a telephone directory, may be acquired, in addition to the number of times of telephone calls from the user, in order to apply the computation rule: ‘if the number of times of telephone calls from the user per minute≧once and the attribute of the counterpart party=‘business colleague’, then the status is ‘working’. If the number of times of incoming telephone calls is substituted for the number of times of telephone call from the user, it is possible to acquire more detailed presence information of the user.

The time information or the schedule table, enclosed in the mobile phone, may similarly be used in combination to estimate that ‘if the number of times of incoming and outgoing telephone calls during working is many, the user is busy’, however, ‘if the number of times of incoming and outgoing telephone calls during the private time is many, the user is not busy’.

(Example of Application 2)

An Example of Application in which the time an unread mail was left unattended is acquired from a mobile phone to issue the presence information is now described. It may be inferred that the longer the time an unread mail is left unattended, the more busy is the user such that the user cannot afford time to read the mail. In the computation rule storage unit, there is stored a computation rule reading: ‘if the time an unread mail is left unattended ≧30 minutes, then the status=“busy”’. If the status computing unit 2 receives “40 minutes” as the time an unread mail is left unattended, the status computing unit outputs the status “busy” in accordance with the aforementioned rule. The presence information issuing unit 5 issues the presence information indicating the status of “busy” to the presence service. In the present Example of Application, the presence information, other than “busy”, indicating that the mail cannot be read at once, can be issued.

(Example of Application 3)

An Example of Application in which the number of unread mails are acquired from a mobile phone to issue the presence information is now described. It may be inferred that the more the number of unread mails, the longer would be the time reading mails has been neglected. In the computation rule storage unit, there is stored a computation rule reading: ‘If the number of unread mails≧“30”, then the status=“mail reading is neglected”’. On receipt of “40” as the number of unread mails; the status computing unit 2 outputs the presence information, indicating that reading mail has been neglected, to the presence service 6, in accordance with the aforementioned rule. The presence information issuing unit 5 issues the presence information, indicating that reading mails is being neglected, to the presence service 6. With the present embodiment, failure in reading mails on the part of the user in these days may automatically be transmitted to the counterpart party. In accessing this user, it is possible to select means other than a mail at the outset.

The status indicating failure in reading a mail may also be issued based not on the number of unread mails but on failure in mail reading even after lapse of a preset time interval.

(Example of Application 4)

An Example of Application in which the response time to the incoming call is acquired from a mobile phone to issue the presence information is explained. It may be inferred that, the longer the response time to the incoming call, the more the user is busy, such that he/she cannot readily respond to the incoming call. In such case, there is stored in the computation rule storage unit 3 a computation rule: ‘If response time to the incoming call≧“30 seconds”, then the status=“busy”’. On receipt of “35 seconds” as the response time to the incoming call, the status computing unit 2 outputs the status “busy” in accordance with the aforementioned rule. The presence information issuing unit 5 issues the presence information indicating “busy” to the presence service 6. In the present embodiment, it is possible to issue the presence information, other than “busy”, indicating that there is some circumstance which renders it difficult for the user to respond to the incoming telephone call.

It may also be inferred that, if the responding time to the incoming telephone call is short, the user is not busy. In addition, on receipt of “7 seconds” as the responding time to the incoming telephone call, the status computing unit 2 may apply a computation rule different from the above rule, namely the rule reading: ‘If the responding time to the incoming telephone call<“30 seconds”, then the status=“on-line”’. The presence information issuing unit 5 issues the presence information other then “on-line” indicating the status in which the user is able to respond readily to the incoming telephone call.

(Example of Application 5)

An Example of Application in which the number of times of mail transmission from a mobile phone per unit time is acquired to issue the presence information is now described. It may be inferred that the more the number of mails transmitted per unit time, the less the user is busy and the more he/she is bored. There is saved in the computation rule storage unit 3 a computation rule reading: ‘If the number of times of mail transmission per unit time≧“thrice”, then the status is “bored”’. On receipt of “five times” as the number of times of mail transmission per unit time, the status computing unit 2 outputs the status “bored” in accordance with the aforementioned rule. The presence information issuing unit 5 issues the presence information, indicating the status of “boredom”, to the presence service 6. In addition to the presence information indicating “boredom”, the presence information indicating the demand for communication on the part of the user may also be issued. With the present Example of Application, the user being desirous to have communication is imparted to watchers other than the counterpart party of mail transmission, thus promoting mail exchange between the user and the watcher.

In such case, it is possible to carry out computations, in cooperation with an address book, in such a manner that counterpart party is busy or not busy if he/she is a colleague of business or is a private friend, respectively. It is also possible to carry out computations, in cooperation with time information or a schedule book, in such a manner that counterpart party is busy or not busy if he/she is a colleague of business or is a private friend, respectively.

(Example of Application 6)

An Example of Application in which the alarm-on time is acquired from a mobile phone to issue the presence information is now described. If the alarm-on time exceeds a preset time interval, it may be inferred that the user is absent or otherwise in a status unable to turn off the alarm. In the computation rule storage unit 3, there is stored e.g. a computation rule reading: ‘If alarm-on time≧“five minutes”, then the status=“absent”’. On receipt of “ten minutes” as the alarm-on time, the status computing unit 2 outputs the status “absent” to the presence service 6 in accordance with the aforementioned rule. With the present Example, it is possible to issue the presence information, other than the “absence”, indicating the status in which the alarm is on but the user is not aware of it.

Computations may be made of the alarm-on time in combination with the alarm type. For example, a computation rule reading: ‘If alarm on time≧“ten minutes”, and alarm type=“alarm clock”, then the status=“offline”’ may be applied in order to suppress an incoming telephone call under a status in which the user is in bed or is a poor riser. A computation rule reading: ‘If alarm on time <“10 seconds” and alarm type=alarm clock”, then the status=“comfortable”’ may also be applied to notify that the user has just risen but is available.

In case the status in which the alarm of the mobile phone is not stopped by the user and kept ringing for a preset time until it is stopped automatically may be detected to infer that the user is not in a status of using the mobile phone. In such case, a computation rule reading: ‘If alarm is stopped automatically, then the status=“offline”’, for example may be applied.

(Example of Application 7)

An Example of Application in which the number of times of the pressing down of a button per unit time is acquired from a mobile phone to issue the presence information is now described. In case a button has been pressed down a large number of times per unit time, it may be inferred that the user is preoccupied in operating the mobile phone and is busy. In the computation rule storage unit, there is saved a computation rule reading: ‘If the number of times of pressing down the button per minute≧“120”, then the status=“busy”’. On receipt of “130” as the number of the pressing down of the button per minute, the status computing unit 2 outputs the status “busy” in accordance with the aforementioned rule. The presence information issuing unit 5 issues the presence information indicating “busy” to the presence service 6. In addition to the presence information “busy”, the presence information indicating that the user is preoccupied in operating the mobile phone may be issued. With the present Example, the fact that the user is preoccupied in the operation of the mobile phone may automatically be imparted to the watchers. The watcher about to make a telephone call to the user may wait for a while before making the call.

It may also be contemplated to infer more correct busyness on the part of the user by acquiring the number of times of the pressing down of the button during the backlight-on period. For example, a computation rule reading: ‘If the number of times of the button pressing down operation during the backlight-on period≦“five times”, then the status=“boredom”’ may be applied.

(Example of Application 8)

An Example of Application in which the number of times of lid opening/closure of a mobile phone is acquired from a mobile phone to issue the presence information is now described. It may be inferred that the more frequently the lid is opened/closed, the less the user is busy. In this case, there is stored in the computation rule storage unit 3 a computation rule reading: ‘If the number of times of lid opening/closure per minute≧“25 times”, then the status=“not busy”’. On receipt of “30 times” as the number of times of the lid opening/closure per minute, the status computing unit 2 outputs the status “not busy” in accordance with the aforementioned rule. The presence information issuing unit 5 issues the presence information indicating the “not busy” to the presence service 6. In addition to the “not busy”, the presence information indicating the user not having anything to do may also be issued. With the present Example, the fact that the user has nothing to do may automatically be imparted to the watchers. The watcher about to make a telephone call may be apprized of the tact that he/she may call the user over telephone without any inconvenience.

(Example of Application 9)

An Example of Application in which the packet communication time within unit time is acquired from a mobile phone to issue the presence information is now described. It may be inferred that the longer the packet communication time, the more busy is the user.

In the computation rule storage unit 3, there is saved a computation rule reading: “If the packet communication time per 60 minutes≧“40 minutes”, then the status is “busy”’. On receipt of “50 minutes” as the packet communication time, the status computing unit 2 outputs the status “busy” in accordance with the aforementioned rule. The presence information issuing unit 5 issues the presence information indicating the “busy” to the presence service 6. In addition to the “busy”, the presence information indicating that the user is tied up may also be issued. With the present Example, the fact that the user is tied up may automatically be imparted to the watchers. The watcher about to make a telephone call may wait for a while before making the call.

(Example of Application 10)

An Example of Application in which the URL of the content browsed from the mobile phone by the Web browser is acquired to issue the presence information is now described. The user's status can be inferred from the URL of the contents by defining, from the outset, the user's status that may be inferred from the sorts of the contents. For example, a computation rule reading: ‘If browsed URL=“prize site”, then the status=“boredom”’ may be applied to apprize the user's status that may be inferred from the prize site, such as “boredom”.

Other examples of the computation rules that may be applied include: ‘If browsed URL=“cross-over retrieval” then the status=“busy” ’ and ‘If browsed URL=“gourmet retrieval” then the status=“want to go out to drink”’.

It may be inferred whether or not the user feels bored, by the application of the mobile phone he/she is using. For example, a computation rule reading: “If a game is enjoyed then the status=“boredom”’ may be applied.

The number of times an antenna is extended or retracted per unit time may be acquired to infer whether or not the user feels bored. For example, the computation rule reading: “if the number of times of antenna extension and retraction per minute≧five times, then the status=“bored”’ may be applied.

(Example of Application 11)

An Example of Application in which failure in authentication of a user owning a mobile phone is detected to issue the presence information is now described. While there are password-based, fingerprint-based and face-based authentication systems, no limitations are imposed here on the particular authentication systems. Should the number of times of failure in user authentication occur a number of times exceeding a preset value, it may be inferred that a third party is using the phone. In the computation rule storage unit 3, there is stored in the computation rule storage unit 3 a computation rule reading: ‘If the number of times of failure in user authentication≧three times, then the status=“an unidentified person is handling the phone”’. On receipt of “four times” as the number of times of the inputting of the erroneous password, the presence information issuing unit 5 issues the presence information, representing “an unidentified person is handling the phone”, to the presence service 6. In addition to the presence information indicating “an unidentified person is handling the phone”, the presence information indicating that a third party is attempting to intrude into protected data of a mobile phone may also be issued. With the present Example of Application, the user being desirous to have entrance to the protected data of a mobile phone may automatically be imparted to a watcher. In case the owner of the mobile phone is a watcher, he/she may take measures for physical protection of the mobile phone.

The following computation rule reading: ‘If the number of times of failure in authentication≧once, then the status=“offline”’, which infers that the mobile phone is lent or borrowed, and is being used by a party other than the owner of the phone, may possibly be used. For example, the presence information indicating that, during the time a mobile phone is lent to a friend of the owner, the owner cannot be contacted, may be notified to a watcher. On receipt of this notice, the watcher may refrain from making a call to the mobile phone being used by e.g. a user's friend.

(Example of Application 12)

An Example of Application, in which the sound volume of the surrounding noise is acquired from a mobile phone to issue the presence information, is now described. In the computation rule storage unit 3, there is stored a computation rule reading: ‘If “80 dB”≦sound volume≦“100 dB” then the status=“cannot make telephone call”’. On receipt of “85 dB” as the sound volume of the noise, the status computing unit 2 outputs a status: “telephone call cannot be made” in accordance with the above rule. The presence information issuing unit 5 issues to the presence service 6 the presence information: “no telephone call can be made”. In particular, if the surrounding noise is not less than 80 dB, such that talk over the telephone is difficult, the effect indicating that the telephone call cannot be responded to may be issued as the presence information. With the present Example of Application, if the user is in a status it is difficult to make a telephone call, the watcher may select contact means other than telephone from the outset.

(Example of Application 13)

An Example of Application in which the surrounding noise is analyzed from the mobile phone to issue the presence information is now described. If, as a result of noise analysis, the sound is found to be that of the electric rolling stock, it may be inferred that the user is in transit.

With the above Example of Application, the surrounding noise is acquired not only during the timing of call of the mobile phone but also by turning a microphone on at all times, only periodically or only when a preset condition is satisfied.

(Example of Application 14)

An Example of Application in which the contents of conversation in speech communication by a mobile phone are analyzed by the conversation parameter extracting unit 1, inclusive of the speech recognition system, to issue the presence information, is now described. The speech recognition system, included in the conversation parameter extracting unit 1, extracts a registered keyword from the contents of the user's utterances. In the computation rule storage unit 3, there is stored a computation rule for inferring the presence information of the user, associated with each keyword. A computation rule reading: “If a keyword “sad” is uttered, then the status=“depressed in feeling”, for example is stored. The present Example of Application is made up by a mobile phone and a presence issuing module 20 in the conversation parameter extracting unit 1 of which is included the speech recognition system. Meanwhile, the presence issuing module 20 may be provided as a presence server.

### Second Embodiment

Referring to FIG. 5, the presence issuing module 21 according to a second embodiment is now described. In the present second embodiment, the utterance unit 7 queries whether or not the user is in a good condition, and an answer received is analyzed by the conversation parameter extracting unit 1 which includes the speech recognition system, to issue the presence information. In the computation rule storage unit 3, there is stored a computation rule reading: ‘If the answer to the query “how is your condition?” is “leave me alone”, then the status=“depressed in feeling”’. On receipt of “leave me alone” as the answer to the query “how is your condition?”, the status computing unit 2 issues the status=“depressed in feeling”, in accordance with the above rule. The presence information issuing unit 5 issues the presence information, indicating the status of being “depressed in feeling”, to the presence service 6. In particular, by the utterance unit 7 accosting the user, the presence information may be issued spontaneously responsive to changes in the user's feeling, humor or stress degree even in such case where the user is not willing to make the conversation voluntarily.

With the second embodiment, such an effect of promoting the communication from a watcher may be derived. The second embodiment may be made up by a mobile phone, and by the presence issuing module 21 in the conversation parameter extracting unit 1 of which is included the speech recognition system. The presence issuing module 21 may also be provided as a presence server.

Meanwhile, the presence information, derived by the status computing unit 2, may be reverted to the former presence information, prior to change, or replaced by other computations or other user operations, after lapse of a preset time.

That is, the presence issuing module 21 of the second embodiment has the utterance unit 7 newly added to the presence issuing module 20 of the first embodiment, and may be assumed to be a robot having the conversation with human beings. By the utterance unit 7 accosting the user, changes in the user's feeling, humor or stress degree may spontaneously be detected even in case the user is not willing to have conversation voluntarily. The utterance unit 7 has the functions of saving the time of the latest conversation, understanding the conversation with the user, and accosting the user.

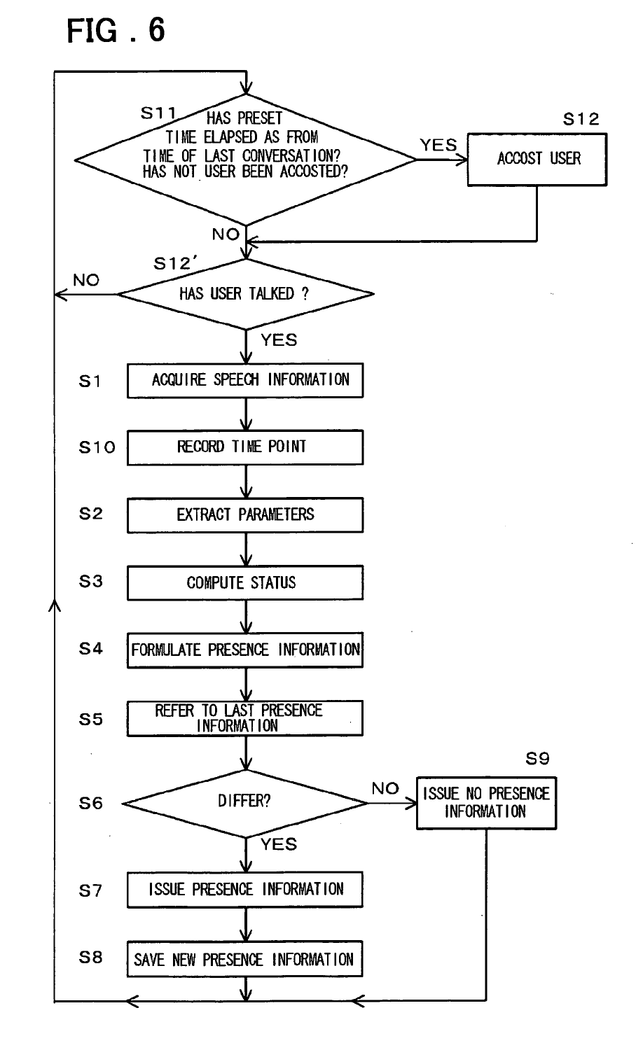

The operation of the second embodiment is now described with reference to FIG. 6 which is a flowchart illustrating the operation of the second embodiment.

Step S1 (Acquisition of speech information): The speech information is entered to the conversation parameter extracting unit 1.

Step S10 (Time point recording): When the user has the conversation, the utterance unit 7 updates the time of the last conversation to the current time.

The steps S2 to S9 are the same as those of the first embodiment.

Step S11 (Has preset time elapsed as from the time of the latest conversation? And has not the user been accosted?): The utterance unit 7 is monitoring the time elapsed as from the time of the last conversation.

Step S12 (Accosting the user): If the time interval during which no conversation with the user has been made has surpassed a preset value, the utterance unit 7 accosts the user in order to acquire the user's status again.

Step S12′ (Has the user talked?): It is verified whether or not, as a result of the utterance unit 7 accosting the user in the step S12, the user has talked. If the user has talked, the program transfers to the step S1 and, if otherwise, the program reverts to a step S11.

With the use of a robot having a more advanced natural language understanding capability, it may be envisaged to handle the information pertinent to words or contexts as conversation parameters. For computation rules, a highly advanced inference function may be introduced. It is possible to issue multifarious presence information by making inferences from parameters pertinent to words or contexts.

The utterance unit 7 may further include means for holding the last input time point of the operation input information, as the input information, and means for executing a preset operation input invoking procedure in case there lacks no new operation input after lapse of a preset time as from the last input time point of the operation input information as held by the holding means. In such case, the operation input information is entered to the utterance unit 7 along with the user's voice information.

The operation input information is the operation input information in the user device, such as PDA or mobile phone, into which is built the presence issuing module 21. Meanwhile, the inputting of the operation input information is omitted in FIG. 5.

In the flowchart shown in FIG. 6, the step S11 reads: ‘Has preset time elapsed as from the time of inputting the last operation? And has not the procedure of invoking the operation input been as yet executed?’, the step S12′ reads: ‘Execute the procedure of invoking the operation input.’, and the step S1 reads: ‘Acquire the operation input information.’. An Example of Application, which is based on this operation input information, is now described as Examples of Application 15 to 19.

(Example of Application 15)

This Example of Application is such a one in which a device, such as a mobile phone, produces an action for the user to prompt the user to make an input to the status computing unit 2.

Such an Example of Application may be implemented in which, when no mail has been received for a preset time period, the mobile phone makes mail distribution registration for various services to prompt inputting to the status computing unit 2. In case the user has no person to whom to transmit a mail, the presence information can be issued on acquisition of the time during which unread mails have been left unattended.

(Example of Application 16)

Such an Example of Application may be implemented in which, when there is no incoming call for a preset time period, the mobile phone requests callback to various services to prompt inputting to the status computing unit 2. In case no one phones the user, the presence information can be issued on acquisition of the response time of incoming call of the user phone.

(Example of Application 17)

In case the presence information has not been updated for a preset period of time, the link to the Web content may be displayed by the mobile phone on its screen to prompt the user to browse the Web content. In case the user does not browse the Web content voluntarily, the URL of the Web contents browsed by the user may be acquired to issue the presence information.

When the mobile phone is in a waiting for incoming call, links may be displayed. Among the contents of the link destination, there are news, weather forecast, flash reports for sports, application for prizes or audition sites for incoming melodies.

The links to various contents may be advertisements from business organizations. The user may be apprized by light, sound or oscillations of the fact that an advertisement is being displayed. When the mobile phone demonstrates the links on the screen, backlights, for example, may be automatically turned on to enable facilitated viewing of the screen by a user.

(Example of Application 18)

In case the presence information has not been updated for a preset time period, such an Example of Application may be implemented in which an application of a mobile phone is booted to prompt the inputting to the status computing unit 2. Even if the user does not voluntarily boot the application, the sort of the application exploited by the user or the information on the number of times of key actuation may be acquired to issue the presence information.

In particular, in the case of a game application, characters or abaters of a game may invite the user to play a game. It is also possible to boot an application in need of periodic interactions, such as pet nurturing game, to prompt the user to make an input to the status computing unit 2.

(Example of Application 19)

In case the presence information has not been updated for a preset time period, such an Example of Application may be implemented in which an alarm of the mobile phone is actuated to prompt the inputting to the status computing unit 2. If the user does not set the alarm voluntarily, the information on alarm actuation time or the number of times of key actuation may be acquired to issue the presence information.

The Example may also be adapted so that, when the time zone, for which no schedule has been set, is impending, the mobile phone actuates an alarm to prompt the inputting to the status computing unit 2. This method is effective when the user's status cannot be inferred from the schedule.

### Third Embodiment

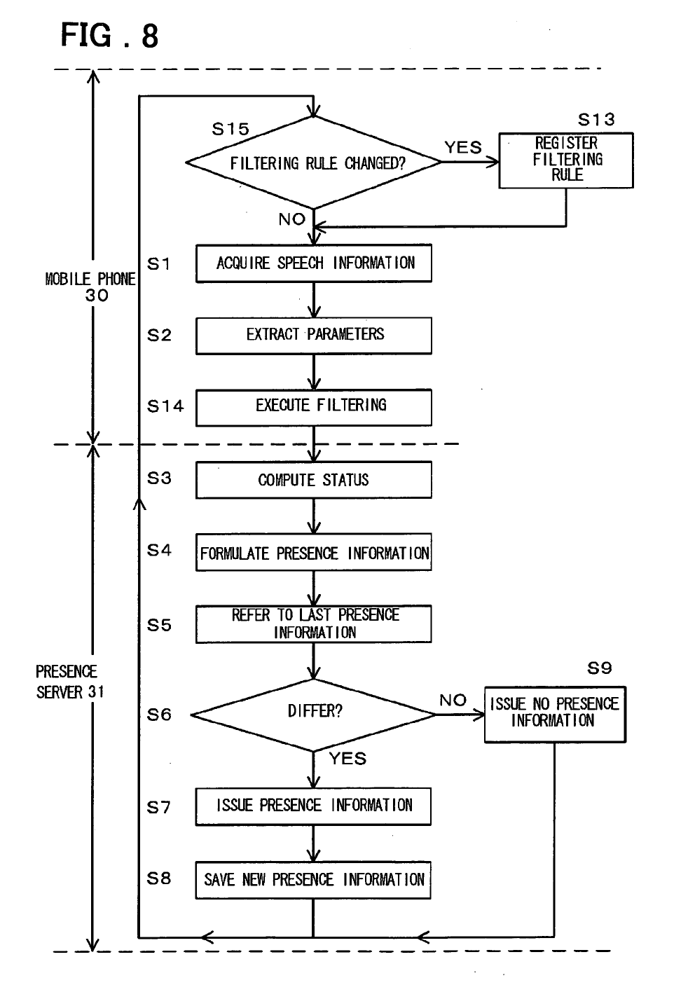

A third embodiment of the present invention is now described with reference to FIGS. 7 and 8. FIG. 7 shows the configuration of a presence information issuing system of the third embodiment of the present invention. The first and second embodiments are directed to the presence issuing module 20 or 21, and a mobile phone as its speech inputting means. The inputting means is, however, not limitative. Conversely, the third embodiment, now explained, is directed to a presence information issuing system, comprising a mobile phone 30 and a presence server 31.

The third embodiment is made up by the mobile phone 30, presence server 31 and the presence service 6. The mobile phone 30 has enclosed therein the conversation parameter extracting unit 1, conversation parameter transmitting unit 9 and the policy management unit 8. The conversation parameter transmitting unit 9 sends parameters, pertinent to the conversation, as collected by the conversation parameter extracting unit 1, to the presence server 31. A network may be interposed between the mobile phone 30 and the presence server 31. In case the conversation parameter is sent over a network, the information pertinent to the privacy of an individual may be filtered by the conversation parameter transmitting unit 9. The policy management unit 8 supervises the filtering rule in filtering conversation parameters for transmission to outside the mobile phone. The presence server 31 includes the conversation parameter receiving unit 10, computation rule storage unit 3, status computing unit 2, presence information issuing unit 5 and the presence information storage unit 4. The conversation parameter receiving unit 10 may receive conversation parameters transmitted from the mobile phone 30. The presence server 31 issues the presence information of the user to the presence service 6 to take the place of the mobile phone 30.

Referring to FIG. 8, the operation of the third embodiment is described with reference to FIG. 8, which depicts a flowchart showing the operation of the third embodiment.

Step S13 (Registration of filtering rules): The user registers the filtering rules in the policy management unit 8, in order not to transmit parameters pertinent to the pitch of the voice to the presence server 31.

Step S1 (Acquisition of the speech information): The speech information is entered to the conversation parameter extracting unit 1.

Step S2 (Parameter extraction): Parameters are extracted in the same way as in the step S2 of the first embodiment. The conversation parameter extracting unit 1 delivers the parameters to the conversation parameter transmitting unit 9.

Step S14 (Filtering): The conversation parameter transmitting unit 9 carries out filtering in accordance with the filtering rules acquired from the policy management unit 8. Specifically, such a method may be contemplated in which specified parameter values, which should not be sent, are replaced by statistically calculated mean values. If the filtering rule, registered in the step S13, is applied, the voice pitch=“medium”.

The conversation parameter transmitting unit 9 transmits conversation parameters over a network to the presence server 31.

The conversation parameter receiving unit 10 receives the parameters from the mobile phone 30 to deliver it to the status computing unit 2.

The steps S3 to S9 are the same as those of the first embodiment.

Step S15 (Is there change in filtering rules?): If there is any change in the filtering rules, such changes filtering rules are re-registered (S13).

Meanwhile, the present embodiment may be applied not only to the mobile phone 30, but also to a fixed phone. In the present embodiment, the presence information prepared by the presence server 31 may be returned to the mobile phone 30 which then issues the presence information in the presence service 6. In this case, the user may confirm the presence information, formulated by the presence server 31 on the basis of the conversation, on the mobile phone 30.

### Fourth Embodiment

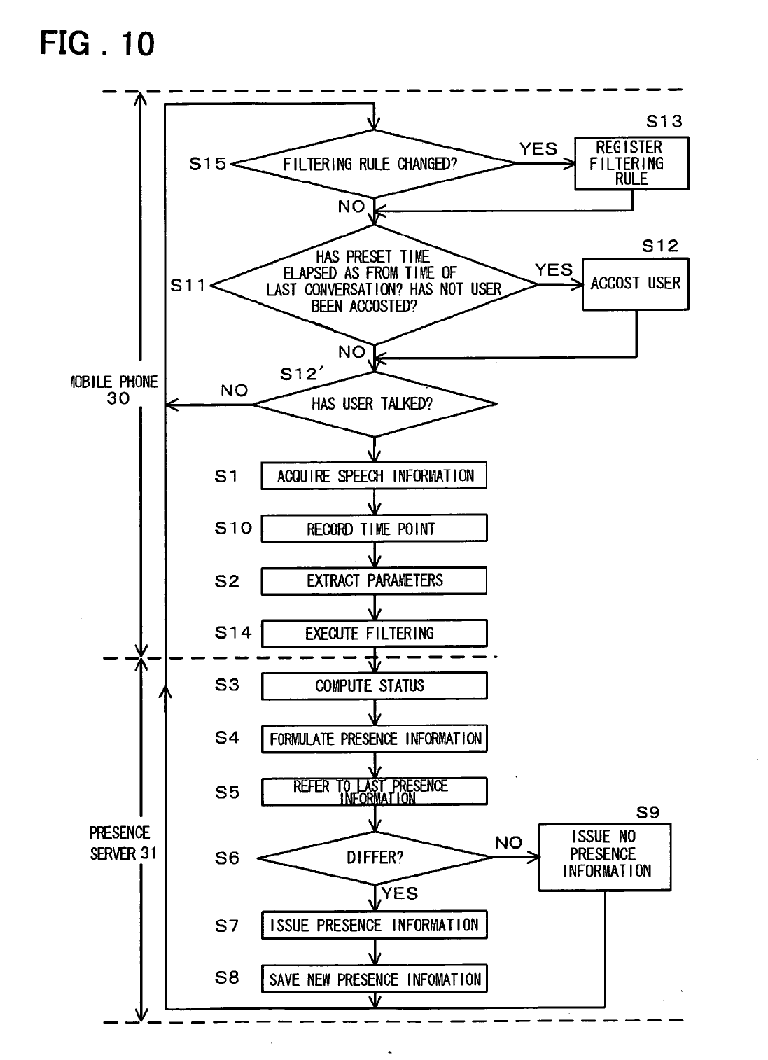

Referring to FIGS. 9 and 10, a fourth embodiment is now described. FIGS. 9 and 10 depict a block diagram of a mobile phone of the present fourth embodiment, and a flowchart showing the operation of the fourth embodiment, respectively. Referring to FIG. 9, the fourth embodiment comprises the mobile phone 30 of the third embodiment shown in FIG. 7 and the utterance unit 7 of the second embodiment shown in FIG. 5. The operation of the fourth embodiment is the combination of the flowcharts of FIGS. 6 and 8. That is,

Step S13 (Registration of the filtering rules): The user registers the filtering rule in the policy management unit 8, lest the voice pitch parameters should be transmitted to the presence server 31.

Step S1 (Acquisition of speech information): The speech information is entered to the conversation parameter extracting unit 1.

Step S10 (Recording the time point): When the user has had conversation, the utterance unit 7 updates the time point of the latest conversation to the current time.

Step S2 (Parameter extraction): Parameters are extracted in the same way as in the step S2 of the first embodiment. The conversation parameter extracting unit 1 delivers the parameters to the conversation parameter transmitting unit 9.

Step S14 (Execution of filtering): The conversation parameter transmitting unit 9 carries out filtering in accordance with the filtering rules acquired from the policy management unit 8. Concretely, specified parameter values, which should not be transmitted, are replaced by statistically calculated average values. If the filtering rules, registered in the step S13, are applied, the voice pitch=“medium”.

The conversation parameter transmitting unit 9 transmits the conversation parameters over the network to the presence server 31.

The conversation parameter receiving unit 10 receives the parameters from the mobile phone 30 to deliver the so received parameters to the status computing unit 2.

The steps S3 to S9 are the same as those of the first embodiment described above.

Step S15 (Is there any change in the filtering rules?): If there is any change in the filtering rules, the filtering rules are registered again (S13).

Step S11 (Has preset time elapsed as from the time of the latest conversation? And has the user not as yet be accosted?): The utterance unit 7 is monitoring the time elapsed as from the time of the latest conversation.

Step S12 (Accosting the user): If the status devoid of conversation with the user has persisted for longer than a preset time, the utterance unit again accosts the user, in order to acquire the user's status again.

Step S12′ (Has the user talked?): It is verified whether or not, as a result of the utterance unit 7 having accosted the user, the user has talked and, if the result is affirmative, the program transfers to the step S1. If otherwise, the program reverts to the step S11. In FIG. 10, the program returns from the step S12′ through the step S15 back to the step S11. Or, the program may directly return from the step S12′ to the step S11. In this case, however, the filtering rules cannot be changed until the user talks.

With the use of a robot having a more advanced natural language understanding capability, it may be envisaged to handle the information pertinent to words or contexts as conversation parameters. For computation rules, a highly advanced inference function may be introduced. It is possible to issue multifarious presence information by making inferences from parameters pertinent to words or contexts.

Meanwhile, the present embodiment may be applied not only to the mobile phone 30, but also to the fixed phone. In the present embodiment, the presence information prepared by the presence server 31 may be returned to the mobile phone 30 which then issues the presence information in the presence service 6. In this case, the user may confirm the presence information, formulated by the presence server 31 based on the conversation, on the mobile phone 30.

The utterance unit 7 may further be provided with means for holding the last operation inputting time point for the mobile phone 30, and with means for carrying out a preset operation input invoking procedure in case there is no new operation input even after lapse of a preset time period as from the latest operation input time point as held by the holding means. In this case, the operation input information is entered to the utterance unit 7, along with the information on the user's speech. Meanwhile, the inputting of the operation input information is omitted in FIG. 9. Such Example of Application, which is based on the operation input information, is the same as the Application Examples 15 to 19 in the above-described second embodiment.

In the flowchart shown in FIG. 10, the step S11 is: ‘Has preset time elapsed as from the last operation input time point? And has the operation input invoking procedure not as yet been executed?’, while the step S12 is: ‘Has the user carried out the operation?’. The step S12′ is: ‘Has the user done the operation?’ and the step S1 is: ‘The operation input information has been acquired.’

Meanwhile, as an exemplary filtering rule in case of employing the operation input information, the user's busyness may be inferred based on the number of times of call transmission or incoming per unit time of the mobile phone 30. However, if the user registers the filtering rules in the policy management unit 8 lest the parameters of the number of times of transmission or incoming should be sent to the presence server 31, then the busyness=“medium”

According to the present invention, the user's current status may be automatically inferred and displayed without relying upon the user's manual input. Hence, the present invention may be used for a system for grasping the status of a user who is unable to enter his/her status on his or her own, such as children or demented elderly persons. Or, the present invention may be applied to a robot performing movements as it grasps the user's status, or may be used for services for interchanging reciprocal feeling or humor during talk over the telephone.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

1. An apparatus for issuing presence information comprising:
extracting means for extracting at least one parameter making up input information;
inferring means for inferring the status of a source of transmission of said input information based on said parameter extracted by said extracting means;
holding means for holding the status inferred last time by said inferring means; and
means for comparing the status inferred last time and held by said holding means and the status inferred for the present time by said inferring means, and for outputting the status inferred for the present time by said inferring means as the status information in case the status inferred last time and held by said holding means and the status inferred for the present time by said inferring means differ from each other.

2. The apparatus according to claim 1, further comprising means for holding one or plurality of inference computation rules for said inferring means.

3. The apparatus according to claim 1, further comprising:
last input time holding means for holding the last input time of said input information which is the speech information; and
means for sending out a preset message as a speech signal in case no new speech information is entered even after lapse of preset time as from the last input time held by said last input time holding means.

4. The apparatus according to claim 1, further comprising:
last input time holding means for holding the last input time of said input information which is operation input information; and
means for executing a preset operation input invoking procedure in case no operation input is entered even after lapse of preset time as from the last operation input time held by said last input time holding means.

5. A presence information issuing system comprising:
a user device which includes:
extracting means for extracting one or plurality of parameters making up input information; and
filtering means for filtering out at least one of said one or plurality of parameters extracted by said extracting means; and
a presence server which includes:
inferring means for inferring the status of a source of transmission of said input information based on said parameter filtered out by said filtering means;
holding means for holding the status inferred last time by said inferring means; and
means for comparing the status inferred last time and held by said holding means and the status inferred for the present time by said inferring means, and for outputting the status inferred for the present time by said inferring means as the status information in case the status inferred last time and held by said holding means and the status inferred for the present time by said inferring means differ from each other.

6. The presence information issuing system according to claim 5, further comprising:
means for holding one or plurality of filtering rules used by said filtering means; and
means for holding one or plurality of inference computation rules for said inferring means.

7. The presence information issuing system according to claim 5, further comprising:
last input time holding means for holding the last input time of said input information which is the speech information; and
means for sending out a preset message as a speech signal in case no new speech information is entered even after lapse of preset time as from the last input time held by said last input time holding means.

8. The presence information issuing system according to claim 5, further comprising:
last operation input time holding means for holding the last operation input time by a user for said user device; and
means for executing a preset operation input invoking procedure in case no operation input is entered even after lapse of preset time as from the last operation input time held by said last operation input time holding means.

9. A user device comprising:
extracting means for extracting one or plurality of parameters making up input information; and
filtering means for filtering out at least one of said one or plurality of parameters extracted by said extracting means.

10. The user device according to claim 9, further comprising means for holding one or plurality of filtering rules used by said filtering means.

11. The user device according to claim 9, further comprising:
last input time holding means for holding the last input time of said input information which is the speech information; and
means for sending out a preset message as a speech signal in case no new speech information is entered even after lapse of preset time as from the last input time held by said last input time holding means.

12. The user device according to claim 9, further comprising
last operation input time holding means for holding the last operation input time by a user to the user device; and
means for executing a preset operation input invoking procedure in case no operation input is entered even after lapse of preset time as from the last operation input time held by said last operation input time holding means.

13. A presence server comprising:
inferring means for inferring the status of a source of transmission of input information based on at least one parameter extracted from said input information;
holding means for holding the status inferred last time by said inferring means; and
means for comparing the status inferred last time and held by said holding means and the status inferred for the present time by said inferring means, and for outputting the status inferred for the present time by said inferring means as the status information in case the status inferred last time and held by said holding means and the status inferred for the present time by said inferring means differ from each other.

14. The presence server according to claim 13, comprising
means for holding one or plurality of inference computation rules for said inferring means.

15. A computer program installed on an information processing apparatus, for enabling said information processing apparatus to implement the functions equivalent to those of a presence information issuing apparatus, comprising the functions of:
extracting at least one parameter making up input information;
inferring the status of a source of transmission of said input information based on said parameter extracted by said extracting functions;
holding the status inferred last time by said inferring function; and
comparing the status inferred last time and held by said holding function to the status inferred for the present time to output the currently inferred status as the status information by said inferring function in case of the two statuses differing from each other.

16. The computer program according to claim 15, for implementing the function of
holding one or plurality of inference computation rules of said inferring functions.

17. The computer program according to claim 15, for implementing the functions of:
holding the last input time point of said input information which is the speech information; and
sending out a preset message as a speech signal in case no new speech information is input even after lapse of a preset time as from the last input time held by said holding function.

18. The computer program according to claim 15, for implementing the functions of:
holding the last operation input time by a user to the user device; and
executing a preset operation input invoking procedure in case no operation input is entered even after lapse of preset time as from the last operation input time held by said holding function.

19. A computer program installed on an information processing apparatus, for enabling said information processing apparatus to implement the functions equivalent to those of a user device comprising the functions of:
extracting one or plurality of parameters making up input information; and
filtering out at least one of said one or plurality parameters extracted by said extracting function.

20. The computer program according to claim 19, for implementing the functions of holding one or plurality of filtering rules employed by said filtering functions.

21. The computer program according to claim 19, for implementing the functions of:
holding the last input time of said input information which is the speech information; and
sending out a preset message as a speech signal in case no new speech information is entered even after lapse of preset time as from the last input time held by said holding function.

22. The computer program according to claim 19, for implementing the functions of
holding the last operation input time by a user to a user device; and
executing a preset operation input invoking procedure in case no operation input is entered even after lapse of preset time as from the last operation input time held by said holding function.

23. A computer program installed on an information processing apparatus, for enabling said information processing apparatus to implement the functions equivalent to those of a presence server including the functions of
inferring the status of a source of transmission of input information based on at least one parameter extracted from input information;
holding the status inferred last time by said inferring function; and
comparing the status inferred last time and held by said holding function and the status inferred for the present time by said inferring function, and for outputting the status inferred for the present time by said inferring function as the status information in case the status inferred last time and held by said holding function and the status inferred for the present time by said inferring function differ from each other.

24. The computer program according to claim 23, for implementing the functions of
holding one or plurality of inference computation rules for said inferring function.
